(19) United States
(12) Patent Application Publication
(10) Pub. No.: US 2025/0336029 A1
(43) Pub. Date: Oct. 30, 2025

(54) ADAPTIVE SCALING FOR MULTI-RESOLUTION PROCESSING IN MACHINE LEARNING SYSTEMS AND APPLICATIONS

(71) Applicant: NVIDIA Corporation, Santa Clara, CA (US)

(72) Inventors: Swapnil Rathi, Pune (IN); Bhushan Rupde, Pune (IN); Vishal Kumar, Hyderabad (IN); Kaustubh Purandare, San Jose, CA (US)

(21) Appl. No.: 18/649,699

(22) Filed: Apr. 29, 2024

(51) Int. Cl. G06T 3/40; G06T 7/62; G06V 10/25

(52) U.S. Cl. CPC G06T 3/40; G06T 7/62; G06V 10/25

(57) ABSTRACT

In various examples, sizes of images that are to be applied to machine learning models may be evaluated with respect to thresholds that correspond to input resolutions of the models. In some examples, if the size of an image is smaller than a threshold corresponding to a certain model's input resolution, the image may be incorporated into a frame that has the same resolution as that model's input resolution. For instance, the image may be copied into the frame at the image's original size, and the rest of the frame may include padding around the image to maintain the frame's resolution at the input resolution. This frame, which may include both the image and the padding, may then be applied to the model. In this way, the image may still be applied to the model at the model's input resolution without scaling and potentially distorting the image.

### BACKGROUND

A data processing pipeline may include a cascading sequence of machine learning models where the output of one model may at least partially be used to determine an input for a subsequent model. This dependency can be particularly significant when a data processing pipeline includes one or more subsequent models that analyze progressively smaller regions of the original input data. As the regions of analysis being evaluated using the pipeline become progressively smaller, it may be necessary to scale the data output from a previous model so that the next, subsequent model can effectively process the data at a suitable resolution. However, such scaling operations may lead to inaccuracies associated with the outputs of these subsequent models. For instance, as the data is scaled, one or more portions of the data may lose detail, become distorted, blurry, noisy, and/or the like. As such, the outputs of the subsequent models may include accuracy losses, false-positives, misdetections, classification errors, and/or the like.

### SUMMARY

Embodiments of the present disclosure relate to adaptive scaling of input data for machine learning systems and applications, particularly those systems and applications that use cascading processing pipelines. Systems and methods are disclosed that may be used to determine an amount to scale input data that is to be applied to a machine learning model. For instance, input data that is smaller than a threshold may be scaled by a first amount—or not scaled at all—such that a resolution associated with the input data may be less than a network resolution, while input data that is larger than the threshold may be scaled to a size associated with the network resolution. In this way, model performance and/or GPU use may be improved while reducing scaling artifacts.

In contrast to conventional approaches, the systems of the present disclosure, in some embodiments, determine whether to adjust a size of an image that is to be applied, as an input, to one or more machine learning models. For instance, the size of the image is evaluated with respect to a threshold, which may correspond to an input resolution (e.g., training resolution) associated with the machine learning model(s). In some examples, if the size of the image is determined to be smaller than the threshold based on the evaluation, the image is incorporated, at a first resolution, into a frame having a size that corresponds to the input resolution. That is, the image is copied into a first portion of the frame at the image's original resolution—or a larger resolution, in some instances—and the remaining portion of the frame may include padding values to maintain the size of the frame at the input resolution. In this way, the first resolution of the copied image (and/or other input data) will include less points (e.g., pixels, lidar points, etc.) than the input resolution associated with the machine learning model(s). In one or more embodiments, if the size of the image is determined to be greater than the threshold based on the evaluation, the image is scaled down and incorporated into the frame at the input resolution.

### BRIEF DESCRIPTION OF THE DRAWINGS

The present systems and methods for adaptive scaling of input data for machine learning systems and applications are described in detail below with reference to the attached drawing figures, wherein:

FIG. 1 is a data flow diagram illustrating an example process that may at least partially be performed using one or more portions of a data processing pipeline, in accordance with some embodiments of the present disclosure;

FIG. 2 illustrates example detail associated with image data that may be processed using a data processing pipeline, in accordance with some embodiments of the present disclosure;

FIG. 3 illustrates example detail associated with a scaled image frame that may be determined using at least a portion of a data processing pipeline, in accordance with some embodiments of the present disclosure;

FIG. 4 illustrates example detail associated with one or more predictions that may be determined using one or more machine learning models of a data processing pipeline, in accordance with some embodiments of the present disclosure;

FIGS. 5A and 5B illustrate example detail associated with incorporating one or more cropped image frames into one or more input frames that are to be applied to one or more machine learning models of a data processing pipeline, in accordance with some embodiments of the present disclosure;

FIG. 6 is a data flow diagram illustrating an example process associated with training one or more machine learning models to determine predictions using adaptively scaled input data, in accordance with some embodiments of the present disclosure;

FIG. 7 illustrates example detail associated with various instances of input data that may be used to train one or more machine learning models, in accordance with some embodiments of the present disclosure;

FIG. 8 is a flow diagram illustrating an example method associated with adaptively scaling image data that is to be applied to one or more machine learning models, in accordance with some embodiments of the present disclosure;

FIG. 9 is a flow diagram illustrating an example method associated with adaptively scaling image data based at least on a size associated with an object depicted in the image data, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

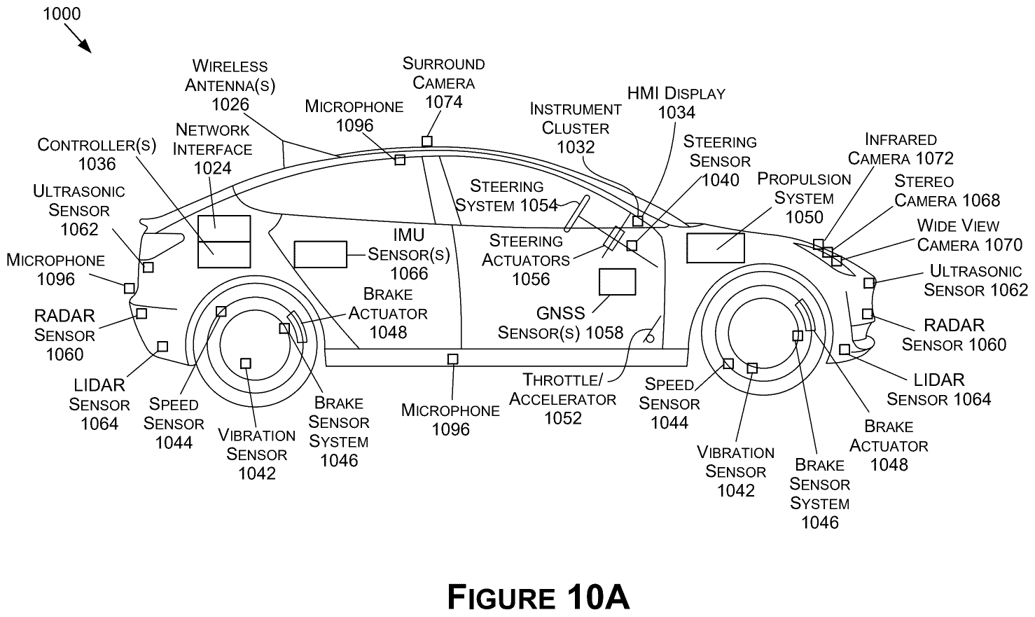

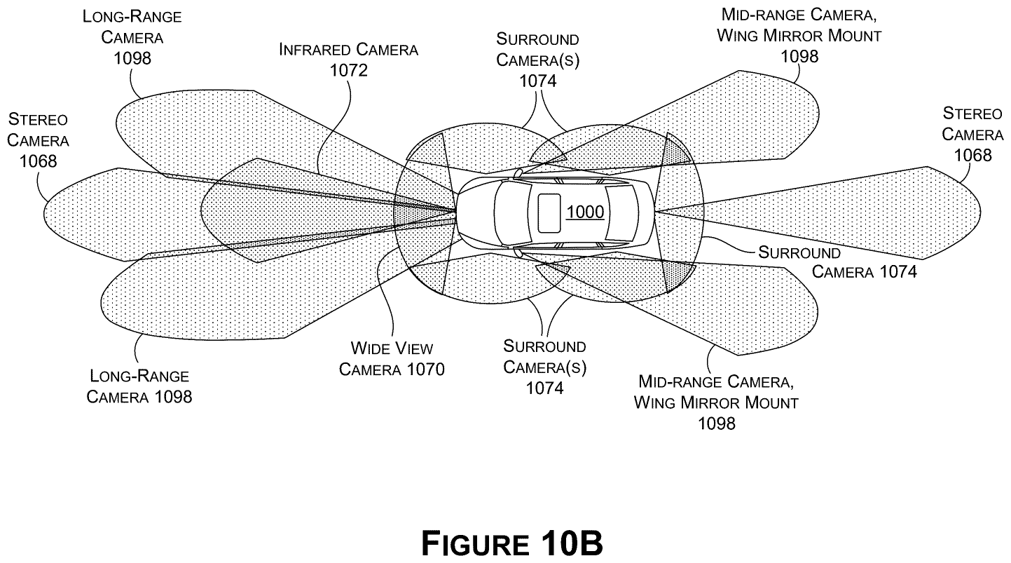

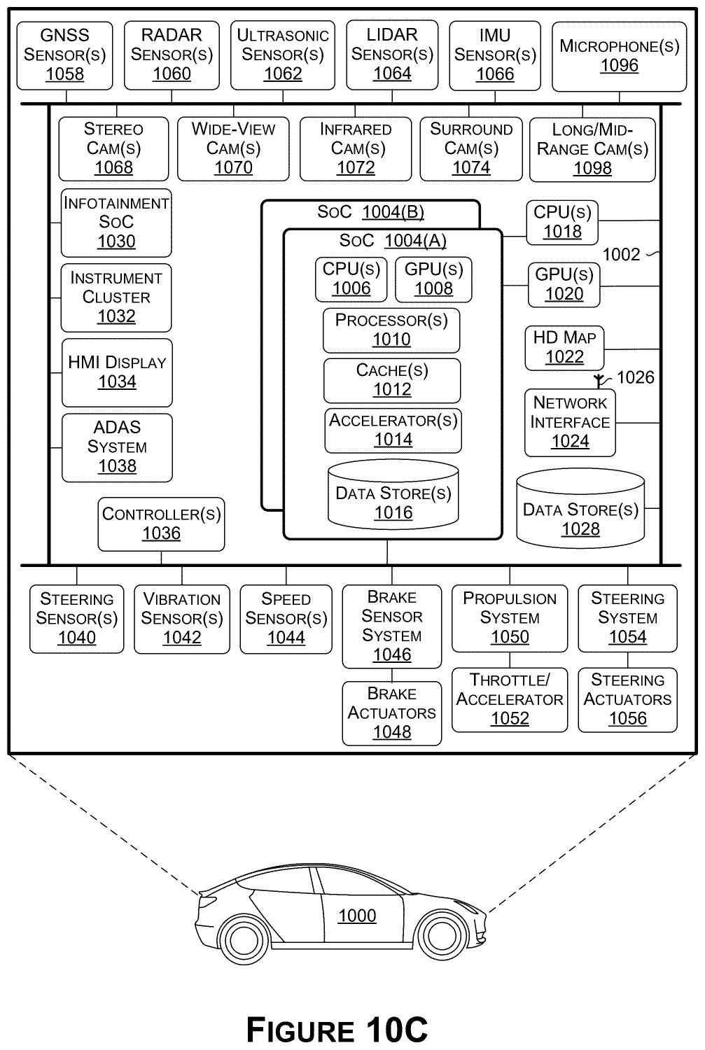

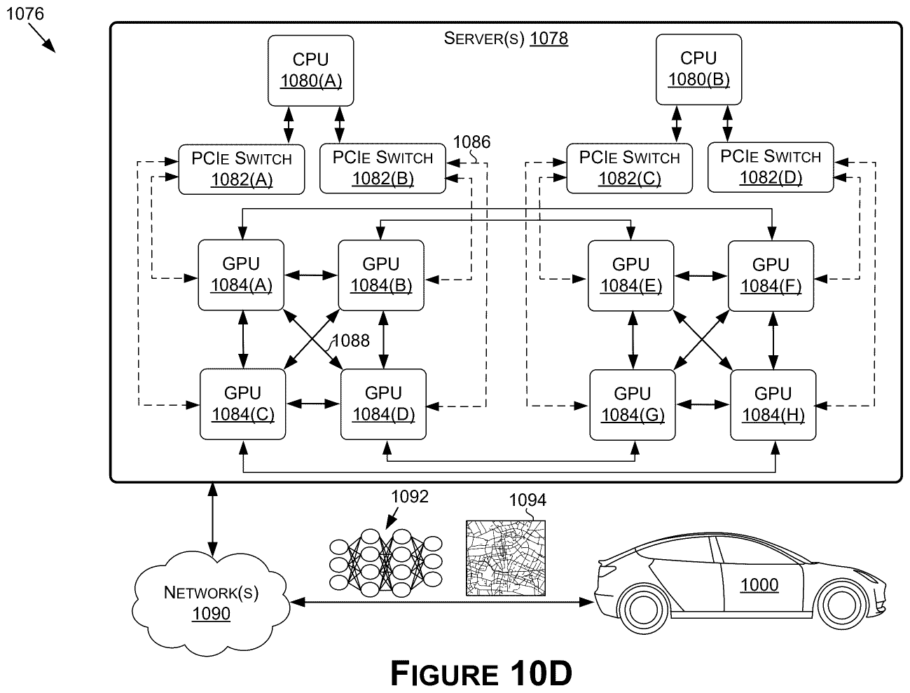

Systems and methods are disclosed related to adaptive scaling of input data for machine learning systems and applications. Although the present disclosure may be described, in some examples, with respect to an example autonomous or semi-autonomous vehicle or machine 1000 (alternatively referred to herein as “vehicle 1000,” “ego-vehicle 1000,” “ego-machine 1000,” or “machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types, as well as non-vehicular contexts. In addition, although several examples of the present disclosure may be described with respect to certain vehicular contexts, this is not intended to be limiting, and the systems and methods described herein may be used in augmented reality, virtual reality, mixed reality, robotics, security and surveillance, autonomous or semi-autonomous machine applications, and/or any other technology spaces where machine learning models and/or cascading, data processing pipelines may be used to determine predictions from input data.

For instance, a system(s) may cause image data (e.g., one or more image frames) to be applied, as an input, to a data processing pipeline. In some examples, the data processing pipeline may include various machine learning models, algorithmic processes, components, and/or the like for determining predictions associated with the image data. The data processing pipeline may correspond to a cascading pipeline in which output(s) from one portion of the pipeline are used as inputs to another portion of the pipeline. For example, the data processing pipeline may include one or more first machine learning models that determine one or more first outputs based at least on the inputted image data, one or more second machine learning models that determine one or more second outputs based at least on the first output(s), and so forth.

In some examples, as the image data (and/or other data) is processed using the pipeline, a size and/or resolution associated with the image data may change as the image data and/or portions of the image data are applied to the various models of the pipeline. In this way, the size/resolution of the inputs to the model(s) of the pipeline may correspond to the size/resolution of the training data used to train the model(s). For example, when the image data is initially received and/or applied to the pipeline, the image data may be at a first size/resolution (e.g., 1920×1080 pixels). However, the image data and/or one or more portions of the image data may be scaled (e.g., during preprocessing) by a first amount when applied to the first machine learning model(s) (e.g., scaled to 1280×720 pixels). Additionally, the image data and/or the portion(s) of the image data of the outputs of the first machine learning model(s) may further be scaled and/or cropped by a second amount when applied to the second machine learning model(s) (e.g., scaled and/or cropped to 720×480 pixels). As such, the inputs applied to the first machine learning model(s) may correspond to a first size/resolution and the inputs applied to the second machine learning model(s) may correspond to a second size/resolution, and so forth.

As noted above, the image data may initially be applied to the first machine learning model(s), and the first machine learning model(s) may generate or otherwise determine one or more first outputs. In some instances, the first output(s) of the first machine learning model(s) may include one or more first prediction(s) associated with one or more objects depicted in the image data. The one or more first prediction(s) may include, but is/are not limited to, a location(s) of the object(s), a bounding shape(s) associated with the object(s), and/or a size(s) of the object(s). As an example, the system(s) may use the first machine learning model(s) to analyze the image data and determine, as the first output(s), one or more regions in the image data that correspond to the object(s). The first output(s) may then be used by one or more downstream components, modules, model(s), etc., of the pipeline.

In some instances, the system(s) may determine one or more image frames (e.g., cropped image frames) corresponding to the object(s) and/or the region(s) based at least on the first output(s). The image frame(s) may include one or more portions of the image data that correspond to the object(s). For instance, the image frame(s) may include one or more points (e.g., pixels) of the image data that correspond to the bounding shape(s) associated with the object(s). By way of example, and not limitation, the image data initially applied as the input to the data processing pipeline may correspond to a single image depicting multiple objects in a field of view of a camera, and this single image may be associated with a first size and/or first resolution. However, based at least on the first machine learning model(s) determining the first output(s), the system(s) may determine the image frame(s) associated with one or more objects of the multiple objects depicted in the single image, which may be associated with one or more second sizes and/or second resolutions that are smaller/less than the first size/resolution (e.g., one or more smaller image frames from within the original, single image frame).

In some examples, the system(s) may determine size data indicating one or more sizes (e.g., dimensions) associated with the image frame(s) and/or the object(s) depicted in the image frame(s). As described herein, the size(s) associated with the image frame(s) and/or the object(s) may include, but is/are not limited to, a resolution(s) of the image frame(s) and/or the object(s), a number(s) of points within the image frame(s) and/or corresponding to the object(s), a height dimension(s) associated with the image frame(s) and/or the object(s), a width dimension(s) associated with the image frame(s) and/or the object(s), and/or an aspect ratio(s) associated with the image frame(s) and/or the object(s). For example, the size data may indicate that a resolution associated with a first image frame of the image frame(s) is 250×400. That is, the size data may indicate that the width of the first image frame is 250 pixels and that the height of the first image frame is 400 pixels.

The system(s) may then evaluate the size(s) with respect to one or more threshold(s) to determine whether and/or how much to scale the image frame(s) prior to applying them as input(s) to the second machine learning model(s) of the data processing pipeline. In some examples, the threshold(s) may correspond to one or more input resolutions associated with the second machine learning model(s). The input resolution(s) may, in some instances, be the same as, or similar to, a training resolution or a network resolution associated with the second machine learning model(s). That is, the input resolution(s) may be the same as, or similar to, the resolution of training data (e.g., training images) used to train the second machine learning model(s). In some instances, a size and/or resolution associated with the threshold(s) may be based on (e.g., similar to, the same as, a function of, etc.) the input resolution(s) associated with the second machine learning model(s). As a first example, if the input resolution of the second machine learning model(s) is, for instance, 600×600 (600 pixels wide by 600 pixels high), the threshold(s) may also be set at 600×600. That is, a first threshold may be set at 600 pixels wide, and a second threshold may be set at 600 pixels high. As a second example, if the input resolution is still 600×600, the threshold(s) may be set at 550×550, 450×450, 300×450, etc. That is, in the second example, the threshold(s) may be set to one or more dimensions that are smaller than the input resolution. As a third example, multiple different threshold(s) may be set, and different operations may be performed based on the size(s) of the image frame(s) with respect to the threshold(s). For instance, a first threshold(s) may be set at 150×150, a second threshold(s) may be set at 300×300, a third threshold(s) may be set at 450×450, and so forth.

Based on the evaluation of the size(s) with respect to the threshold(s), the system(s) may determine whether to—and/or a magnitude by which—to scale the image frame(s) prior to applying them as an input to the second machine learning model(s). In some examples, if the size(s) associated with the image frame(s) and/or the object(s) is less than the threshold(s), the system(s) may determine to refrain from scaling or otherwise adjusting the size(s) of the image frame(s). By way of example, and not limitation, if the input resolution is 600×600, the threshold(s) is set to 400×400, and the size(s) associated with the image frame(s) corresponds to a resolution that is less than 400×400 (e.g., 350×250), the system(s) may refrain from scaling the image frame(s). To provide the image frame(s) to the second machine learning model(s) without being scaled, the system(s) may copy the image frame(s) into one or more buffers (e.g., memset frame buffers) that correspond to the input resolution of the second machine learning model(s). That is, the system(s) may use the buffer(s) in combination with the image frame(s) to generate one or more input frames having a size that corresponds to the input resolution. For instance, the image frame(s) may be copied into the buffer(s) such that a first portion of the input frame includes data corresponding to the image frame(s) at the desired resolution (e.g., 350×250 in the above example) and a second portion (e.g., remaining portion) of the input frame includes one or more padding values.

Additionally, or alternatively, the system(s) may determine to increase the size(s) of the image frame(s) by a certain amount such that the updated size(s) of the image frame(s) may still be associated with a resolution(s) that is less than the input resolution of the second machine learning model(s), but nonetheless larger than the resolution determined from the first output(s). By way of example, and not limitation, if the input resolution of the second machine learning model(s) is 600×600, a first threshold(s) is set to 400×400, a second threshold(s) is set to 200×200, and the size(s) associated with the image frame(s) corresponds to a resolution that is less than 200×200, the system(s) may determine to increase the size(s)/resolution(s) of the image frame(s). For instance, the system(s) may increase the size(s)/resolution(s) of the image frame(s) to 300×300, 400×400, 500×500, etc. However, the system(s) may, in some instances, increase the size(s)/resolution(s) by no more than the input resolution, 600×600 in the above example. In some examples, the system(s) may increase the size(s)/resolution(s) by a set amount, such as by 1.5×, 2×, 3×, etc., the original resolution/size of the image frame(s) or use one or more functions or formula to determine the scaling factor.

In various examples, if the size(s) associated with the image frame(s) and/or the object(s) (and/or region(s)) is greater than the threshold(s) and/or the input resolution(s), the system(s) may determine to decrease the size(s) of the image frame(s) to the input resolution. That is, the system(s) may scale the image frame(s) to the input resolution of the second machine learning models during preprocessing. In some examples, the image frame(s) may be scaled to the input resolution if at least one size (e.g., one dimension) of the image frame(s) is larger than one or more of the threshold(s). By way of example, and not limitation, assume again that the input resolution is 600×600. In such cases, image frame(s) having resolutions meeting or exceeding 600×600 (e.g., 650×650, 600×750, 800×800, etc.) may be scaled down to the input resolution size before being applied as inputs to the second machine learning model(s). Additionally, image frame(s) having at least one resolution dimension that meets or exceeds the input resolution may also be scaled down to the input resolution as well. For instance, still assuming the input resolution and/or threshold is 600×600, image frame(s) having resolutions of, e.g., 400×650, 650×450, 500×605, etc., may all be scaled down to the input resolution(s) before being applied to the second machine learning model(s).

In some examples, the system(s) may further determine whether to scale the image frame(s) based at least on differences between one or more first aspect ratios associated with the image frames and one or more second aspect ratios associated with the input resolution(s) of the second machine learning model(s). That is, even if the size(s) of the image frame(s) is determined to be smaller than the threshold(s) and/or the input resolution(s), the system(s) may still determine to scale the image frame(s) to increase the size(s) of the image frame(s) before applying them to the second machine learning model(s) if the aspect ratios are similar. For instance, if a first resolution of a first image frame is 100×300, a first aspect ratio associated with the first image frame may be determined to be 1:3. If a second resolution of a second image frame is 100×100, a second aspect ratio associated with the second image frame may be determined to be 1:1. If the input resolution(s) of the second machine learning model(s) is 600×600, the input aspect ratio may be determined to be 1:1. In such cases, the system(s) may determine to scale (e.g., increase the size of) the second image frame while refraining from scaling the first image frame. For example, scaling the first image frame from 100×300 (1:3) to 600×600 (1:1) may distort the first image frame and have the effect of stretching the first image frame, which may cause the second machine learning model(s) to make inaccurate predictions. However, the second image frame may be scaled larger without affecting the second aspect ratio, and this may improve the prediction capabilities of the second machine learning model(s).

As described herein, after the image frame(s) is incorporated into the input frame(s) of the input resolution size, the input frame(s) may be applied as input(s) to the second machine learning model(s). The second machine learning model(s) may be configured to determine one or more second predictions associated with the object(s) depicted in the input frame(s). In some examples, the second prediction(s) may include one or more attributes associated with the object(s). The attribute(s) may include, but is/are not limited to, one or more of an orientation(s) of the object(s), a classification(s) of the object(s), a trajectory(ies) of the object(s), a size(s) of the object(s), an action(s) performed by the object(s), whether the object(s) is static or dynamic, a pose(s) of the object(s), and a characteristic(s) of the object(s).

While examples are primarily described in terms of objects and object detection, disclosed approaches are relevant to other forms of predictions made using machine learning models, such as one or more predictions which may be used, at least in part, to determine and/or identify one or more regions and/or subsets of data to be applied to and/or incorporated into input data to one or more machine learning models. Additionally, in one or more embodiments, the one or more regions and/or subsets of data may be determined and/or identified algorithmically and/or without using a machine learning model. While image data is primarily described, other forms of input data may be used in addition to or alternatively from image data. Further, the resolution(s) of data and/or machine learning models described herein may have any suitable dimensions (e.g., 1D, 2D, 3D, . . . ND). In various embodiments, the data may be scaled and/or thresholds may be evaluated with respect to any combination of these dimensions. Also, disclosed approaches may be applied to data processing pipelines that need not include a cascading sequence of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

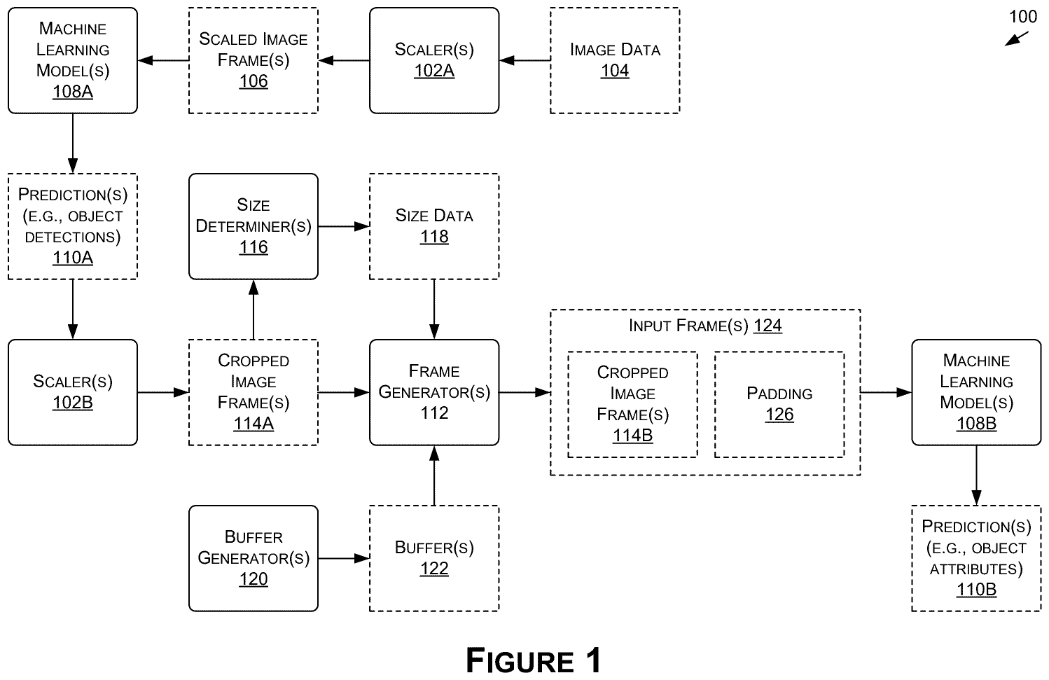

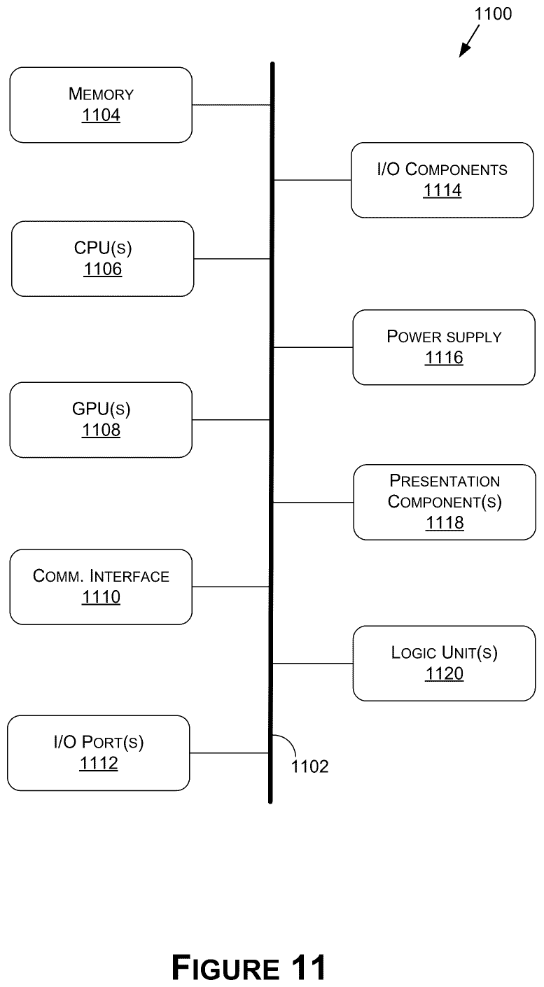

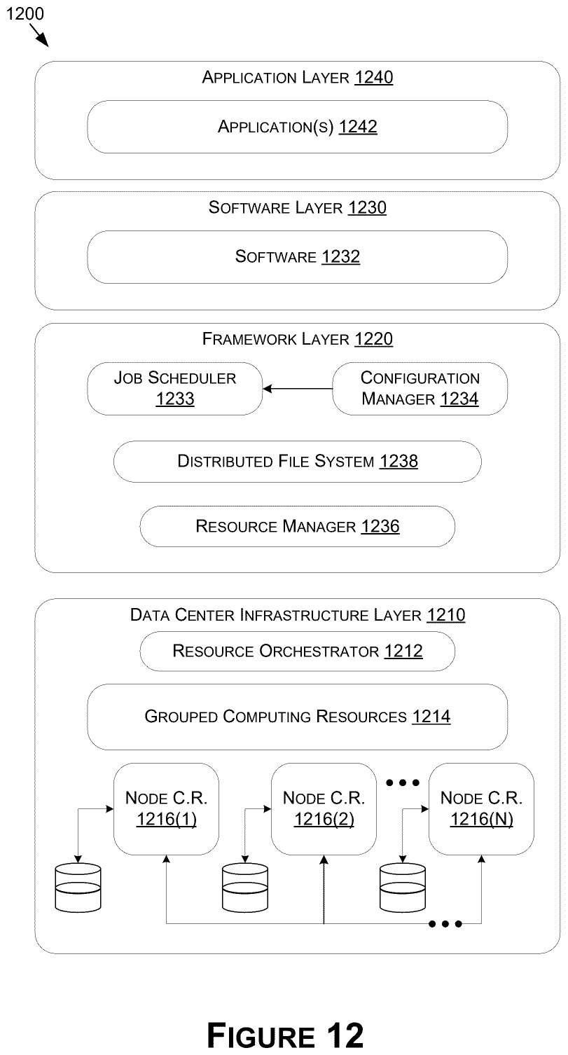

With reference to FIG. 1, FIG. 1 is a data flow diagram illustrating an example process 100 that may at least partially be performed using one or more portions of a data processing pipeline, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-IGD, example computing device 1100 of FIG. 11, and/or example data center 1200 of FIG. 12.

The process 100 may include using one or more first scalers 102A to determine one or more scaled image frames 106 from image data 104. The scaled image frame(s) 106 may then be provided, as an input(s), to one or more first machine learning models 108A, which may determine one or more first predictions 110A (e.g., object detections) based on the scaled image frame(s) 106. The first prediction(s) 110A may then be used by one or more second scalers 102B to determine one or more first cropped image frames 114A. One or more size determiners 116 may determine size data 118 associated with the first cropped image frame(s) 114A, and the size data 118 may be provided to one or more frame generators 112. The frame generator(s) 112 may use the size data 118, the first cropped image frame(s) 114A, and one or more buffers 122 generated by one or more buffer generators 120 to generate one or more input frames 124 that may be applied to one or more second machine learning models 108B. The input frame(s) 124 may include padding 126 and/or one or more second cropped image frames 114B, which may, in some instances, be the same as—or updated/refined (e.g., scaled) versions of—the first cropped image frame(s) 114A. The second machine learning model(s) 108B may output one or more second predictions 110B, such as attributes associated with objects detected using the first machine learning model(s) 108A. The second prediction(s) 110B may, in some examples, be used by the vehicle 1000 to navigate an environment.

As described herein, some or all of the process 100 may correspond to one or more portions of a data processing pipeline for processing the image data 104 and/or other types of sensor data (e.g., LiDAR data, RADAR data, ultrasonic data, etc.). In some examples, the image data 104 may be captured using one or cameras associated with a vehicle that is operating in an environment. As such, the image data 104 may depict one or more portions of the environment associated with a certain field(s) of view of the camera(s). Additionally, the image data 104 may depict one or more objects present in the portion(s) of the environment. However, these examples are not intended to be limiting, and the image data 104 may capture using any type of cameras. Additionally, the process 100 and/or similar processes may process other types of data in addition to, or in the alternative of, the image data 104, such as LiDAR data, RADAR data, ultrasonic data, thermal imaging data, etc.

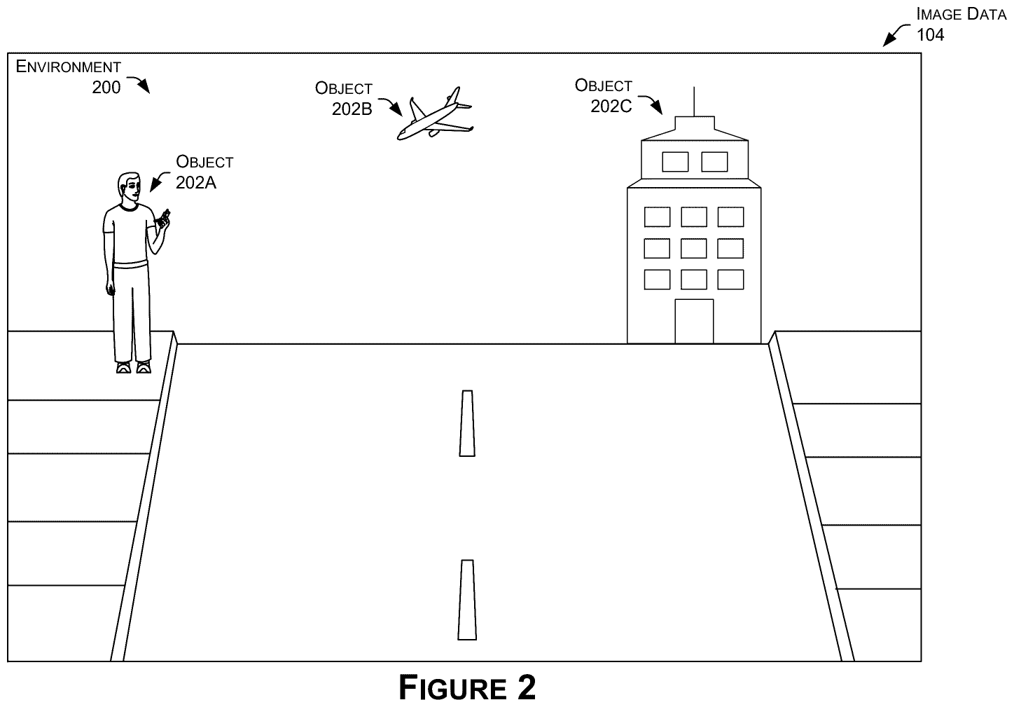

For instance, with reference to FIG. 2, FIG. 2 illustrates example detail associated with the image data 104 that may be processed using the data processing pipeline, in accordance with some embodiments of the present disclosure. The image data 104 illustrated in FIG. 2 represents an image depicting an environment 200 and various objects 202A-202C, which may include both static objects and dynamic objects which may be detected or identified using the machine learning model(s) 108A or some other approach. For instance, a first object 202A that corresponds to a pedestrian and a second object 202B that corresponds to an airplane may be classified as dynamic objects, which are capable of movement. A third object 202C depicted in the image data 104 may correspond to a building and, as such, be classified as a static object because it may not be capable of movement.

With reference back to FIG. 1, in some examples, a size and/or resolution associated with the image data 104 may change as the image data 104 and/or a portion(s) of the image data 104 is processed. For example, when the image data 104 is initially received and/or applied to the first scaler(s) 102A, the image data 104 may be a first size/resolution (e.g., 1920×1080 pixels). However, the first scaler(s) 102A may be configured to scale the image data 104 and/or one or more portions of the image data 104 by a first amount to generate the scaled image frame(s) 106. In this way, the scaled image frame(s) 106 may correspond to a second size/resolution (e.g., 1280×720 pixels) when applied to the first machine learning model(s) 108A. In some examples, the first scaler(s) 102A may correspond to at least a portion of a preprocessing technique that acts on the image data 104 prior to the image data 104 being applied—as the scaled image frame(s) 106—to the first machine learning model(s) 108A.

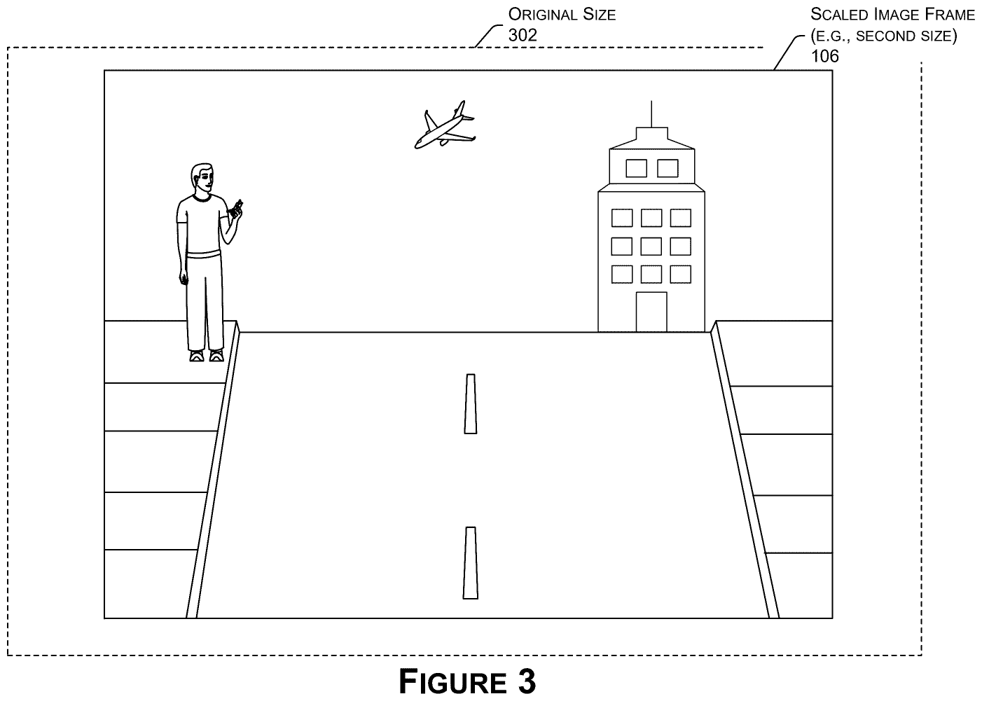

For instance, with reference to FIG. 3, FIG. 3 illustrates example detail associated with a scaled image frame 106 that may be determined using at least a portion of the data processing pipeline, in accordance with some embodiments of the present disclosure. For instance, the scaled image frame 106 may be generated by or using the first scaler(s) 102A. As illustrated in FIG. 3, the scaled image frame 106 may be associated with a second size and/or resolution that is different from an original size 302 and/or resolution associated with the image data 104. Although the example of FIG. 3 is illustrated as the scaled image frame 106 being of a smaller size and/or resolution than the original size 302, the first scaler(s) 102A may, in some examples, be configured to scale the image data 104 to various different sizes, including, but not limited to, larger sizes, wider sizes, taller sizes, smaller sizes, shorter sizes, and narrower sizes. That is, the first scaler(s) 102A may be configured to scale the image data 104 in any direction or dimension.

Now referring back to FIG. 1, the scaled image frame(s) 106 may initially be applied to the first machine learning model(s) 108A, and the first machine learning model(s) 108A may generate or otherwise determine, as an output(s), the first prediction(s) 110A. In some instances, the first prediction(s) 110A may be associated with the object(s) depicted in the scaled image frame(s) 106. The first prediction(s) 110A may include, but is/are not limited to, one or more locations of the object(s), one or more bounding shapes associated with the object(s), and one or more sizes of the object(s). As an example, the first machine learning model(s) 108A may analyze the scaled image frame(s) 106 and determine, as the first prediction(s) 110A, one or more regions in the scaled image frame(s) 106 that correspond to the object(s).

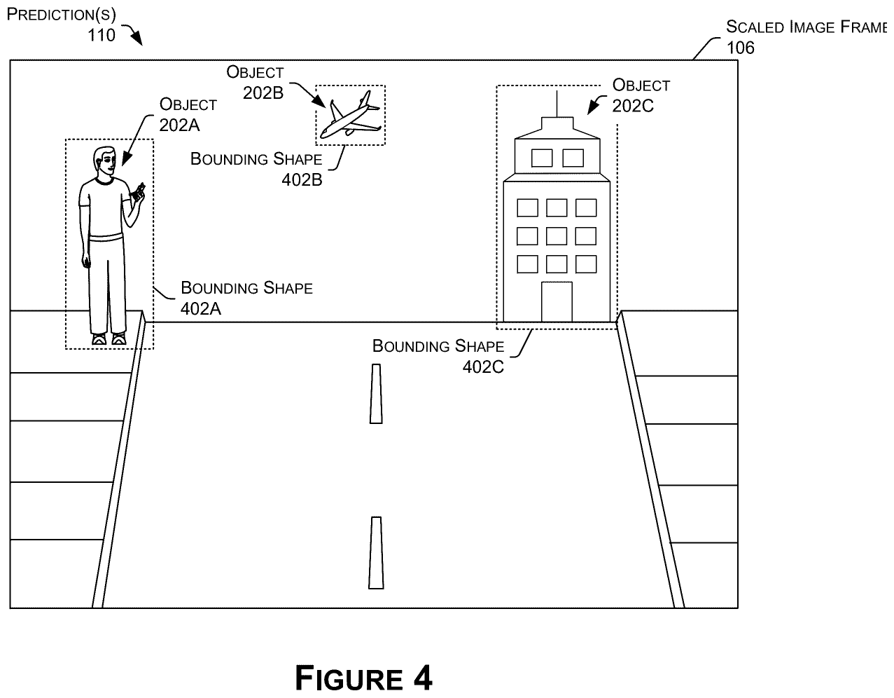

For example, with reference to FIG. 4, FIG. 4 illustrates example detail associated with the one or more predictions 110 that may be determined using one or more machine learning model(s) of the data processing pipeline, in accordance with some embodiments of the present disclosure. The predictions 110 illustrated in FIG. 4 may correspond to the first prediction(s) 110A determined using the first machine learning model(s) 108A. The prediction(s) 110 may be associated with the object(s) 202A-202C depicted in the scaled image frame 106. For instance, the prediction(s) 110 may include one or more bounding shapes 402A-402C associated with the object(s) 202A-202C. The bounding shapes 402A-402C may be indicative of, among other things, one or more sizes associated with the objects 202A-202C, one or more locations associated with the objects 202A-202C, a presence of the objects 202A-202C, and/or the like.

Referring back to FIG. 1, in some examples, the data processing pipeline and/or the process 100 may include one or more other models, components, algorithms, filters, and/or the like between the first machine learning model(s) 108A and the preprocessing second scaler(s) 102B for the second machine learning model(s) 108B. Though not depicted in FIG. 1, the process 100 may include, for example, one or more tracker(s) to track movement and/or positions of the objects throughout a series or sequence of frames of the image data 104, and/or other components, in some instances. In this way, an object detection in a first image can be associated with an object (e.g., the same object) detected in a second image for more accurate object detection.

In some instances, the second scaler(s) 102B may receive the first prediction(s) 110A and determine the first cropped image frame(s) 114A. For example, the second scaler(s) 102B may receive the scaled image frame(s) 106 and/or the first prediction(s) 110A corresponding to the scaled image frame(s) 106, such as the bounding shapes 402A-402C, and the second scaler(s) 102B may generate the first cropped image frame(s) 114A associated with one or more of the objects 202A-202C depicted in the scaled image frame(s) 106. That is, the second scaler(s) 102B may extract image data (e.g., points, pixels, etc.) from one or more regions of the scaled image frame(s) 106 that corresponds to one or more of the objects 202A-202C, and the second scaler(s) 102B may generate the first cropped image frame(s) 114A at one or more resolutions corresponding to the size(s) of the objects 202A-202C (e.g., based on the bounding shapes 402A 402B) using the extracted image data.

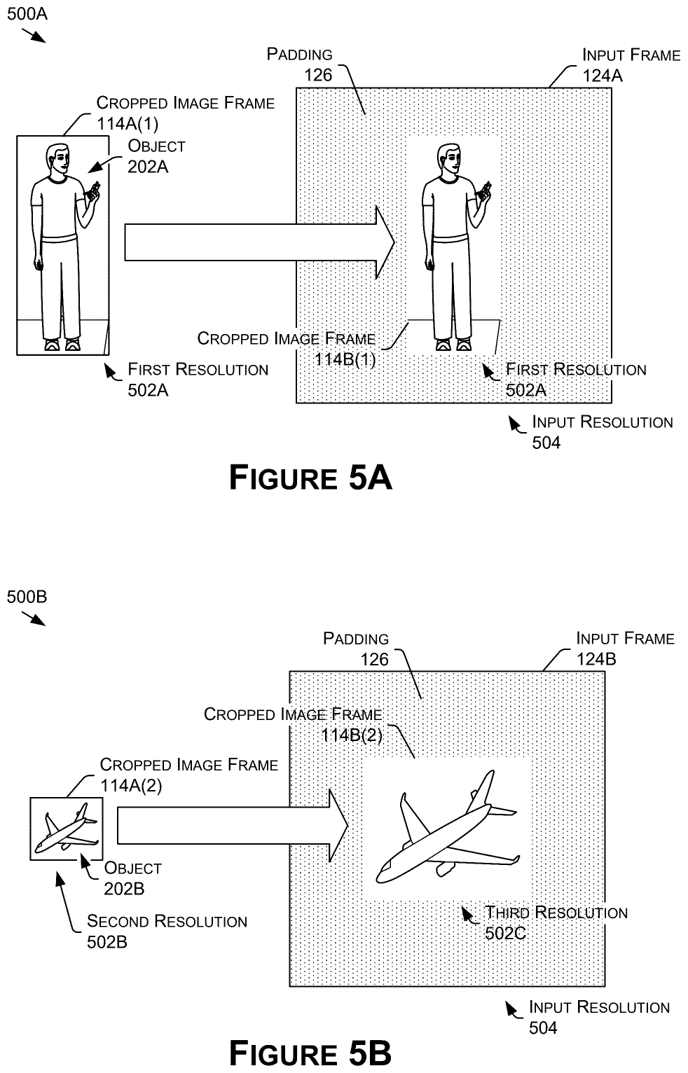

For example, FIGS. 5A and 5B illustrate example detail associated with the first cropped image frame(s) 114A, in accordance with some embodiments of the present disclosure. With reference to FIG. 5A, a first cropped image frame 114A(1) is illustrated, which may be generated by the second scaler(s) 102B from the scaled image frame(s) 106 and/or based at least on the first prediction(s) 110A. The first cropped image frame 114A(1) may correspond to the object 202A and be associated with a first resolution 502A. In some examples, the first resolution 502A may correspond to the original resolution/dimensions of the image data depicting the object 202A as extracted from the scaled image frame(s) 106. Additionally, or alternatively, the first resolution 502A may correspond to the dimensions of the bounding shape 402A. With reference now to FIG. 5B, a second cropped image frame 114A(2) is illustrated, which may also be generated by the second scaler(s) 102B from the scaled image frame(s) 106 and/or based at least on the first prediction(s) 110A. The second cropped image frame 114A(2) may correspond to the object 202B and be associated with a second resolution 502B that is different from the first resolution 502A. In some examples, the second resolution 502B may correspond to the original resolution/dimensions of the image data depicting the object 202B as extracted from the scaled image frame(s) 106. Additionally, or alternatively, the second resolution 502B may correspond to the dimensions of the bounding shape 402B.

Referring back to FIG. 1, the size determiner(s) 116 may determine size data 118 indicating one or more sizes (e.g., dimensions) associated with the first cropped image frame(s) 114A and/or the object(s) depicted in the first cropped image frame(s) 114A. For instance, the size determiner(s) 116 may determine one or more resolutions associated with the first cropped image frame(s) 114A. As described herein, the size(s) associated with the first cropped image frame(s) 114A and/or the object(s) may include, but is/are not limited to, the resolution(s) associated with the first cropped image frame(s) 114A and/or the object(s), a number(s) of points (e.g., pixels) within the first cropped image frame(s) 114A and/or corresponding to the object(s), a height dimension(s) associated with the first cropped image frame(s) 114A and/or the object(s), a width dimension(s) associated with the first cropped image frame(s) 114A and/or the object(s), and an aspect ratio(s) associated with the first cropped image frame(s) 114A and/or the object(s). For example, the size data 118 may indicate that a resolution associated with a first cropped image frame of the first cropped image frame(s) 114A is 250×400. That is, the size data 118 may indicate that the width of the first cropped image frame is 250 pixels wide and that the height of the first image frame is 400 pixels high.

The buffer generator(s) 120 may generate the buffer(s) 122 (e.g., frame buffers) to be provided to the frame generator(s) 112. In some examples, the buffer(s) 122 may be arranged into a frame that is of a size and/or resolution that corresponds to the input resolution(s) associated with the second machine learning model(s) 108B. In some instances, the buffer(s) 122 may be initialized using a memset or similar function to set bits/bytes of the buffer(s) to one or more specific values, such as zero. Additionally, or alternatively, the buffer generator(s) 120 may fill the buffer(s) with other values besides zeros, for instance, values corresponding to one or more solid colors (e.g., black, white, blue, yellow, orange, gray, etc.). However, whichever value the buffer generator(s) 120 initializes the buffer(s) with, the buffer generator(s) 120 may initialize the buffer(s) with the same value for each bit and/or byte.

The frame generator(s) 112 may evaluate the size data 118 corresponding to the first cropped image frame(s) 114A to determine whether or not it may be necessary to scale one or more of the first cropped image frame(s) 114A prior to applying them as inputs to the second machine learning model(s) 108B. For instance, the frame generator(s) 112 may evaluate the size data 118 with respect to one or more thresholds, which may correspond to the input resolution(s) of the second machine learning model(s) 108B. Additionally, the frame generator(s) 112 may determine a magnitude by which individual ones of the first cropped image frame(s) 114A are to be scaled. In either case, the frame generator(s) 112 may generate the input frame(s) 124, which may include the second cropped image frame(s) 114B and, in some instances, the padding 126. The padding 126 may correspond to one or more of the buffer(s) 122 that the frame generator(s) 112 did not copy image data to from the first cropped image frame(s) 114A.

In some examples, the resolutions associated with the second cropped image frame(s) 114B may be the same as or different from resolutions associated with the first cropped image frame(s) 114A. For instance, in some examples the frame generator(s) 112 may copy the first cropped image frame(s) 114A directly into the buffer(s) 122 without changing the resolution, thereby causing the second cropped image frame(s) 114B of the input frame(s) 124 to have the same size/resolution as the first cropped image frame(s) 114A. In other examples, the frame generator(s) 112 may adjust the size/resolution of the first cropped image frame(s) 114A before incorporating them into the buffer(s) 122 and/or the input frame(s) 124 as the second cropped image frame(s) 114B. Because the size/resolution of the second cropped image frame(s) 114B may vary between individual ones of the input frame(s) 124, the size of the padding 126 may also vary between different input frame(s) 124. Additionally, in some examples, the input frame(s) 124 may not include any padding 126 at all, such as in the case that the first cropped image frame(s) 114A and/or the second cropped image frame(s) 114B is or are the same size as the input resolution(s) of the second machine learning model(s) 108B.

In some examples, if the size(s) associated with the first cropped image frame(s) 114A and/or the object(s) is less than the threshold(s), the frame generator(s) 112 may determine to refrain from scaling or otherwise adjusting the size(s) of the first cropped image frame(s) 114A. By way of example, and not limitation, if the input resolution of the second machine learning model(s) 108B is 600×600 and the size(s) associated with the first cropped image frame(s) 114A correspond to a resolution that is less than 600×600 (e.g., 350×250), the frame generator(s) 112 may refrain from scaling the first cropped image frame(s) 114A. To provide the first cropped image frame(s) 114A to the second machine learning model(s) 108B without being scaled, the frame generator(s) 112 may copy the first cropped image frame(s) 114A into one or more portions of the buffer(s) 122. That is, the frame generator(s) 112 may use the buffer(s) 122 in combination with the first cropped image frame(s) 114A to generate the input frame(s) 124 having the size that corresponds to the input resolution. For instance, the first cropped image frame(s) 114A may be copied into the buffer(s) 122 such that a first portion of the input frame(s) 124 includes points and/or pixels corresponding to the first cropped image frame(s) 114A and a second portion (e.g., remaining portion) of the input frame(s) 124 includes the padding 126.

For example, FIGS. 5A and 5B illustrate example detail 500A and 500B associated with incorporating one or more cropped image frames into one or more input frames that are to be applied to one or more second machine learning models of the data processing pipeline, in accordance with some embodiments of the present disclosure. With reference first to FIG. 5A, the detail 500A illustrates how a first cropped image frame 114A(1) associated with the object 202A may be incorporated into a first input frame 124A without scaling. That is, the first cropped image frame 114A(1)—prior to incorporation in the first input frame 124A—may be associated with the first resolution 502A. Then, after being incorporated into the first input frame 124A, the first cropped image frame 114B(1) may still be associated with the first resolution 502A, and the padding 126 may fill in the remaining portions of the first input frame 124A to maintain an input resolution 504 associated with the second machine learning model(s) 108B.

Referring back to FIG. 1, the frame generator(s) 112 may additionally, or alternatively, determine to increase the size(s) of the first cropped image frame(s) 114A by a certain amount such that the updated size(s) of the second cropped image frame(s) 114B in the input frame(s) 124 may still be associated with a resolution that is less than the input resolution of the second machine learning model(s) 108B, but nonetheless larger than the resolution of the first cropped image frame(s) 114A. By way of example, and not limitation, if the input resolution of the second machine learning model(s) 108B is still 600×600 and the size(s) associated with the first cropped image frame(s) 114A correspond to a resolution that is less than a lower threshold (e.g., 200×200), the frame generator(s) 112 may determine to increase the size(s)/resolution(s) of the second cropped image frame(s) 114B corresponding to the first cropped image frame(s) 114A.

For example, and with reference to FIG. 5B, the detail 500B illustrates how a second cropped image frame 114A(2) associated with the object 202B may be incorporated into a second input frame 124B with partial scaling. That is, the second cropped image frame 114A(2) prior to incorporation in the second input frame 124B—may be associated with the second resolution 502B. Then, after being incorporated into the second input frame 124B, the second cropped image frame 114B(2) may be associated with a third resolution 502C, and the padding 126 may fill in the remaining portions of the second input frame 124B to maintain the input resolution 504 associated with the second machine learning model(s) 108B. In some examples, by scaling the cropped image frame 114B(2) to the third resolution 502C, but not quite as large as the input resolution 504, the output accuracies associated with the second machine learning model(s) 108B may be improved for smaller and/or more distant objects depicted in the image data 104.

In other examples, if the size(s) associated with the first cropped image frame(s) 114A and/or the object(s) is greater than the input resolution(s), the frame generator(s) 112 may determine to decrease the size(s) of the first cropped image frame(s) 114A to the input resolution. In some examples, the second cropped image frame(s) 114B may be scaled to the input resolution(s) if at least one size (e.g., one dimension) of the first cropped image frame(s) 114A is larger than one or more of the threshold(s). By way of example, and not limitation, assume again that the input resolution is 600×600. In such cases, the first cropped image frame(s) 114A having resolutions meeting or exceeding 600×600 (e.g., 650×650, 600×750, 800×800, etc.) may be scaled down to the input resolution size before being applied as inputs to the second machine learning model(s) 108B. Additionally, the first cropped image frame(s) 114A having at least one resolution dimension that meets or exceeds the input resolution may also be scaled down to the input resolution as well. For instance, still assuming the input resolution and/or threshold is 600×600, cropped image frame(s) 114A having resolutions of, e.g., 400×650, 650×450, 500×605, etc., may all be scaled down to the input resolution(s) before being applied to the second machine learning model(s) 108B. In at least some examples, the frame generator(s) 112 may lock an aspect ratio of the first cropped image frame(s) 114A when scaling.

As described herein, after the first cropped image frame(s) 114A is incorporated as the second cropped image frame(s) 114B-into the input frame(s) 124, the input frame(s) 124 may be applied as input(s) to the second machine learning model(s) 108B. The second machine learning model(s) 108B may be configured to determine one or more second predictions associated with the object(s) depicted in the input frame(s) 124. In some examples, the second prediction(s) 110B may include one or more attributes associated with the object(s). The attribute(s) may include, but is/are not limited to, one or more of an orientation(s) of the object(s), a classification(s) of the object(s), a trajectory(ies) of the object(s), a size(s) of the object(s), an action(s) performed by the object(s), whether the object(s) is static or dynamic, a pose(s) of the object(s), and a characteristic(s) of the object(s). In this way, the vehicle 1000 may determine a trajectory or planned path to follow through the environment based at least on the second prediction(s) 110B.

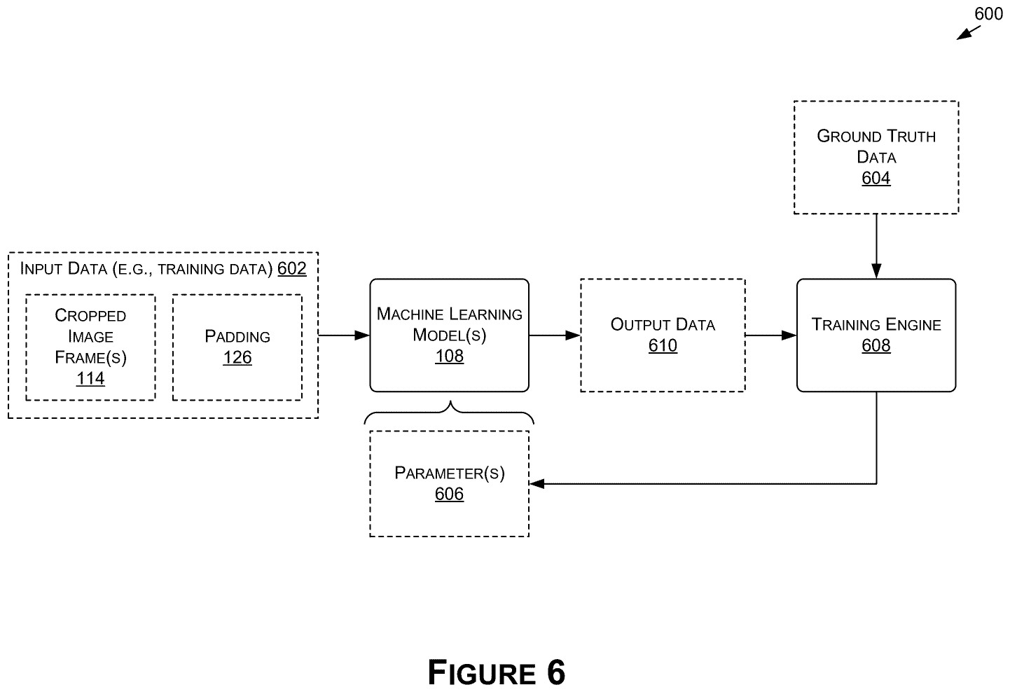

Now referring to FIG. 6, FIG. 6 is a data flow diagram illustrating an example process 600 associated with training one or more machine learning models 108 to determine predictions using adaptively scaled input data, in accordance with some embodiments of the present disclosure. In at least some examples, the machine learning model(s) 108 may correspond to the second machine learning model(s) 108B described above with respect to FIG. 1. As shown, the machine learning model(s) 108 may be trained using input data 602 (e.g., training data). The input data 602 may be similar to the input frame(s) 124 described above with respect to FIG. 1. As such, the input data 602 may include the cropped image frame(s) 114 and, in some instances, the padding 126. In this way, a size and/or resolution of the input data 602 may be held constant during training, but the sizes/resolution and/or locations of the cropped image frame(s) 114 within the input data 602 may vary between training iterations.

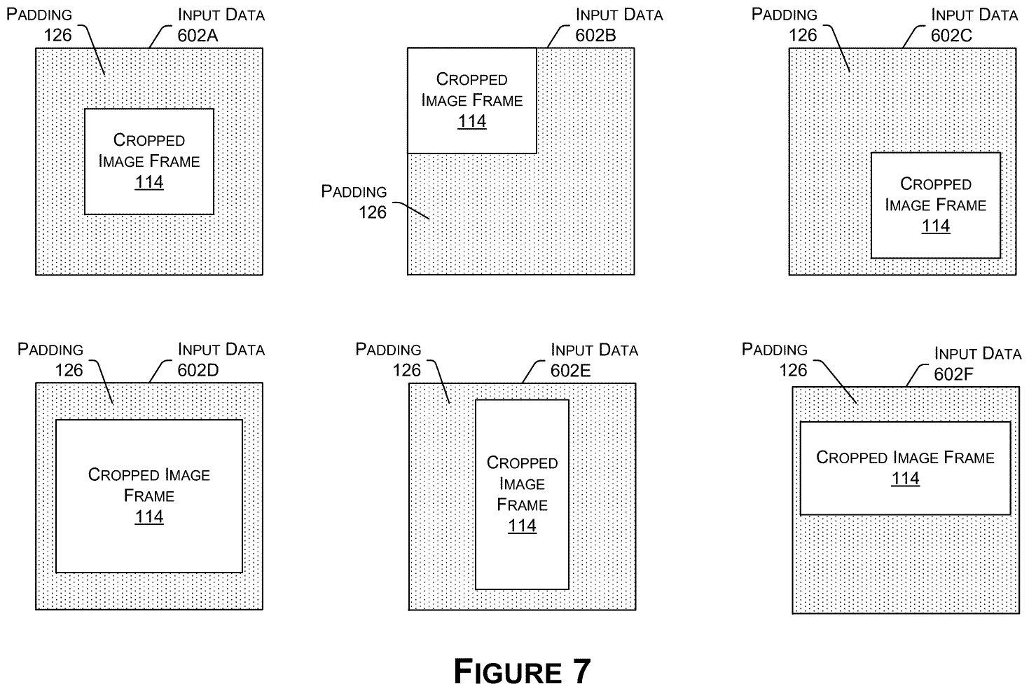

For example, FIG. 7 illustrates various different examples of formatting for input data 602A-602F that may be applied to the machine learning model(s) 108 during training iterations. The input data 602A-602F may include different formats of the padding 126 and the cropped image frame 114, which may all be input to the machine learning model(s) 108 during training. For instance, the first input data 602A is formatted such that the cropped image frame 114 is centered in the frame. The second input data 602B is formatted such that the cropped image frame 114 is in the top left corner of the frame. The third input data 602C is formatted such that the cropped image frame 114 is near the bottom right corner of the frame. The fourth input data 602D is formatted such that the cropped image frame 114 is centered in the frame, but higher resolution and of a different aspect ratio than in the first input data 602A. The fifth input data 602E is formatted such that the cropped image frame 114 is centered in the frame, but having an aspect ratio that is about 1:2.5 length to width. Finally, the sixth input data 602F is formatted such that the cropped image frame 114 is centered and positioned near the top of the frame, and having an aspect ratio that is about 2.5:1 length to width. By applying different formats of the input data 602 during training, the machine learning model(s) 108 may be able to make accurate predictions regardless of the size/resolution and/or how the cropped image frame(s) 114 are included in input data (e.g., centered, offset, etc.)

Referring back to FIG. 6., the machine learning model(s) 108 may be trained using the training input data 602 as well as corresponding ground truth data 604 (which may correspond to the input data 602). That is, although referred to as “ground truth data,” the ground truth data 604 may, in some examples, simply include the same data (e.g., images, etc.) as the input data 602. In some examples, the ground truth data 604 may include annotations, labels, masks, and/or the like. For example, in some embodiments, the ground truth data 604 may indicate actual values associated with the object(s) within the input data 602. For instance, and for an object, the values may include, but are not limited to, a x-coordinate location, a y-coordinate location, a z-coordinate location, a height, a width, a length, a density, RGB values, prediction(s), attribute(s), and/or any other parameter. The ground truth data 604 may be generated within a drawing program (e.g., an annotation program), a computer aided design (CAD) program, a labeling program, another type of program suitable for generating the ground truth data 604, and/or may be hand drawn, in some examples. In any example, the ground truth data 604 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 608 may use one or more loss functions that measure loss (e.g., error) in output data 610 (which may include or otherwise be similar to the prediction(s) 110A and 110B) generated by the machine learning model(s) 108 as compared to the ground truth data 604 and/or the input data 602. In some examples, the training engine 608 may compare the output data 610 from the machine learning model(s) 108 to the input data 602 and optimize the machine learning model(s) 108 based at least on the comparing. That is, the training engine 608 may update/optimize one or more parameters 606 associated with the machine learning model(s) 108 to reduce the losses/differences between the output data 610 and the input data 602. Any type of loss function may be used, such as cross entropy loss, mean squared error, mean absolute error, mean bias error, and/or other loss function types. In some examples, different outputs may have different loss functions. For example, the x-coordinate location may include a first loss, the y-coordinate location may include a second loss, the z-coordinate location may include a third loss, and/or so forth. In such examples, the loss functions may be combined to form a total loss, and the total loss may be used to train (e.g., update the parameter(s) 606 of) the machine learning model(s) 108. In any example, backward pass computations may be performed to recursively compute gradients of the loss function(s) with respect to training parameters. In some examples, weight and biases of the machine learning model(s) 108 may be used to compute these gradients.

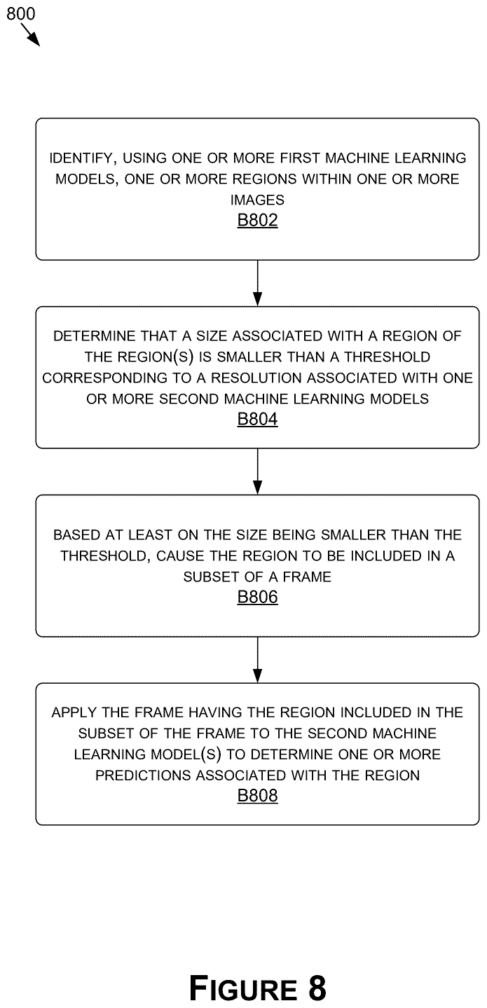

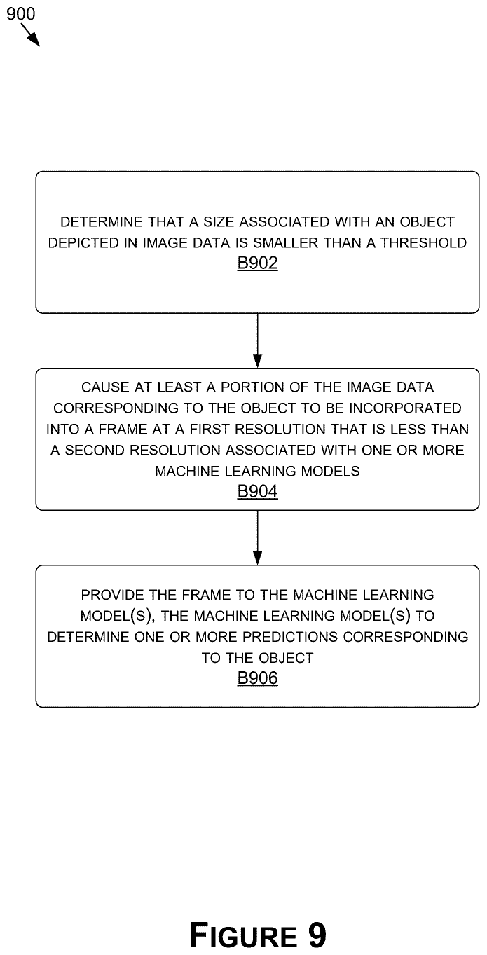

Now referring to FIGS. 8 and 9, each block of the method 800 and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 800 and 900 are described, by way of example, with respect to FIG. 1. However, these methods may additionally or alternatively be executed by any one system, or any combination of systems, including, but not limited to, those described herein.

FIG. 8 is a flow diagram illustrating an example method 800 associated with adaptively scaling image data that is to be applied to one or more machine learning models, in accordance with some embodiments of the present disclosure. The method 800, at block B802, may include identifying, using one or more first machine learning models, one or more regions within one or more images. For instance, the first machine learning model(s) 108A may be used to identify the one or more regions within the scaled image frame(s) 106. As described herein, the region(s) may be included in the prediction(s) 110A, and the region(s) may indicate one or more portions of the scaled image frame(s) 106 that correspond to one or more objects depicted in the scaled image frame(s) 106.

The method 800, at block B804, may include determining that a size associated with a region of the one or more regions is smaller than a threshold corresponding to a resolution associated with one or more second machine learning models. For instance, the frame generator(s) 112 may determine that the size associated with the region is smaller than the threshold. As described herein, the threshold may correspond to the input resolution associated with the second machine learning model(s) 108B. In some examples, the size determiner(s) 116 may determine the size data 118 indicating the size associated with the region, and the frame generator(s) 112 may determine whether that size is less than, meets, or exceeds the threshold.

The method 800, at block B806, may include, based at least on the size being smaller than the threshold, causing the region to be included in a subset of a frame. For instance, the frame generator(s) 112 may cause the region to be included in the subset of the input frame(s) 124. As described herein, the input frame(s) 124 may include the second cropped image frame(s) 114B and, in some instances, the padding 126. A cropped image frame of the second cropped image frame(s) 114B may correspond to the region. That is, the cropped image frame may include points and/or pixels associated with the region from the scaled image frame(s) 106.

The method 800, at block B808, may include applying the frame having the region included in the subset of the frame to the one or more second machine learning models to determine one or more predictions associated with the region. For instance, the frame generator(s) 112 may apply the input frame(s) 124 to the second machine learning model(s) 108B, and the second machine learning model(s) 108B may be configured (e.g., trained) to determine the second prediction(s) 110B associated with the region. In some instances, the second prediction(s) 110B may include a prediction(s) associated with an object(s) depicted in the frame. Such prediction(s) may include, but is not limited to, a classification(s) of the object, a size(s) of the object(s), a trajectory(ies) of the object(s), a pose(s) associated with the object(s), an intent(s) associated with the object(s), and/or a gesture(s) performed by the object(s).

FIG. 9 is a flow diagram illustrating an example method 900 associated with adaptively scaling image data based at least on a size associated with an object depicted in the image data, in accordance with some embodiments of the present disclosure. The method 900, at block B902, may include determining that a size associated with an object depicted in image data is smaller than a threshold. For instance, the frame generator(s) 112 may determine that the size associated with the object depicted in the cropped image frame(s) 114A is smaller than the threshold. In some examples, the size associated with the object may correspond to a size associated with a bounding box corresponding to the object. As described herein, the threshold may correspond to the input resolution associated with the second machine learning model(s) 108B. In some examples, the size determiner(s) 116 may generate the size data 118 indicating the size associated with the object and/or the cropped image frame(s) 114A, and the frame generator(s) 112 may determine whether that size is less than, meets, or exceeds the threshold.

The method 900, at block B904, may include causing at least a portion of the image data corresponding to the object to be incorporated into a frame at a first resolution that is less than a second resolution associated with one or more machine learning models. For instance, the frame generator(s) 112 may cause the portion of the image data 104 corresponding to the object to be incorporated into the input frame(s) 124 at the first resolution that is less than the input resolution associated with the second machine learning model(s) 108B. As described herein, the input frame(s) 124 may include the second cropped image frame(s) 114B and, in some instances, the padding 126. A cropped image frame of the second cropped image frame(s) 114B may include the portion of the image data 104 corresponding to the object. That is, the cropped image frame may include points and/or pixels of the image data 104 that correspond to the object and/or an area surrounding the object.

The method 900, at block B906, may include providing the frame to the one or more machine learning models, the one or more machine learning models to determine one or more predictions corresponding to the object. For instance, the frame generator(s) 112 may provide the input frame(s) 124 to the second machine learning model(s) 108B. As described herein, the second machine learning model(s) 108B may be configured (e.g., trained) to determine the second prediction(s) 110B associated with the object. In some instances, the second prediction(s) 110B may include an attribute(s) associated with the object. Such attribute(s) may include, but is not limited to, a classification(s) of the object, a size(s) of the object(s), a trajectory(ies) of the object(s), a pose(s) associated with the object(s), an intent(s) associated with the object(s), and/or a gesture(s) performed by the object(s).

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060m (front) or 80m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5m, 4m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: identifying, using one or more first machine learning models, one or more regions within one or more images; determining that a size associated with a region of the one or more regions is smaller than a threshold, the threshold corresponding to a resolution associated with one or more second machine learning models; in response to the determining that the size is smaller than the threshold, causing the region to be included in a subset of a frame; and applying the frame having the region included in the subset of the frame to the one or more second machine learning models to determine one or more predictions associated with the region.

B. The method as recited in paragraph A, wherein the causing the region to be included in the subset of the frame comprises causing the region to be included in the frame at a second resolution that includes at least one of fewer points or fewer pixels than the resolution associated with the one or more second machine learning models.

C. The method as recited in any one of paragraphs A-B, further comprising determining that a difference between a first aspect ratio associated with the region and a second aspect ratio associated with the resolution is greater than a second threshold, wherein the causing of the region to be included in the subset of the frame is further based at least on the difference being greater than the second threshold.

D. The method as recited in any one of paragraphs A-C, further comprising: evaluating a second size associated with a second region of the one or more regions with respect to the threshold; determining, based at least on the evaluating, that the second size associated with the second region meets or exceeds the threshold; and based at least on the second size meeting or exceeding the threshold, causing the second region to be included in a second frame at the resolution associated with the one or more second machine learning models.

E. The method as recited in any one of paragraphs A-D, further comprising causing an increase of the size associated with the region from a first resolution to a second resolution, the second resolution including less points or pixels than the resolution associated with the one or more second machine learning models, wherein the causing of the region to be included in the subset of the frame comprises causing the region to be included in the subset of the frame at the second resolution.

F. The method as recited in any one of paragraphs A-E, wherein the resolution associated with the one or more second machine learning models corresponds to one or more resolutions associated with one or more frames of image data used to train the one or more second machine learning models.

G. The method as recited in any one of paragraphs A-F, wherein the size associated with the region corresponds to a second resolution of the region, the second resolution including less points or pixels than the resolution associated with the one or more second machine learning models.

H. The method as recited in any one of paragraphs A-G, wherein the causing of the region to be included in the subset of the frame comprises causing one or more points of image data corresponding to the region to be mapped to one or more locations in the subset of the frame.

I. The method as recited in any one of paragraphs A-I, wherein the one or more regions within the one or more images correspond to one or more locations associated with one or more objects depicted in the one or more images.

J. A system comprising: one or more processors to: determine that a size associated with an object represented in image data is smaller than a threshold; in response to the determination that the size is smaller than the threshold, cause at least a portion of the image data corresponding to the object to be incorporated into a frame at a first resolution that is less than a second resolution associated with one or more machine learning models; and provide the frame to the one or more machine learning models, the one or more machine learning models to determine one or more predictions corresponding to the object.

K. The system as recited in paragraph J, the one or more processors further to determine that a difference between a first aspect ratio associated with the first resolution and a second aspect ratio associated with the second resolution is greater than a second threshold, wherein the causing of the portion of the image data to be incorporated into the frame at the first resolution is further based at least on the difference being greater than the second threshold.

L. The system as recited in any one of paragraphs J-K, the one or more processors further to: determine that a second size associated with a second object depicted in the image meets or exceeds the threshold; and in response to the determination that the second size meets or exceeds the threshold, cause at least a second portion of the image data corresponding to the second object to be incorporated into a second frame at the second resolution.

M. The system as recited in any one of paragraphs J-L, wherein a second size corresponding to the first resolution is larger than the size associated with the object.

N. The system as recited in any one of paragraphs J-M, wherein the second resolution associated with the one or more machine learning models corresponds to one or more resolutions associated with one or more images used to train or update the one or more machine learning models.

O. The system as recited in any one of paragraphs J-N, wherein a second size associated with at least one of the threshold or the frame corresponds to the second resolution associated with one or more machine learning models.

P. The system as recited in any one of paragraphs J-O, the one or more processors further to cause the one or more machine learning models to be updated using one or more frames corresponding to the second resolution, the one or more frames including one or more padded portions at least partially surrounding one or more images, the one or more images having one or more resolutions that are less than the second resolution.

Q. The system as recited in any one of paragraphs J-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language model (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R. One or more processors comprising: one or more circuits to determine whether to adjust a size of an image identified using one or more first machine learning models based at least on evaluating the size of the image with respect to a threshold, the threshold related to an input resolution associated with one or more second machine learning models.

S. The one or more processors as recited in paragraph R, the one or more circuits further to determine, based at least on the evaluating, to incorporate the image into a frame at a second resolution that includes less points or pixels than the input resolution associated with the one or more second machine learning models.

T. The one or more processors as recited in any one of paragraphs R-S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
identifying, using one or more first machine learning models, one or more regions within one or more images;
determining that a size associated with a region of the one or more regions is smaller than a threshold, the threshold corresponding to a resolution associated with one or more second machine learning models;
in response to the determining that the size is smaller than the threshold, causing the region to be included in a subset of a frame; and
applying the frame having the region included in the subset of the frame to the one or more second machine learning models to determine one or more predictions associated with the region.

2. The method of claim 1, wherein the causing the region to be included in the subset of the frame comprises causing the region to be included in the frame at a second resolution that includes at least one of fewer points or fewer pixels than the resolution associated with the one or more second machine learning models.

3. The method of claim 1, further comprising determining that a difference between a first aspect ratio associated with the region and a second aspect ratio associated with the resolution is greater than a second threshold, wherein the causing of the region to be included in the subset of the frame is further based at least on the difference being greater than the second threshold.

4. The method of claim 1, further comprising:
evaluating a second size associated with a second region of the one or more regions with respect to the threshold;
determining, based at least on the evaluating, that the second size associated with the second region meets or exceeds the threshold; and
based at least on the second size meeting or exceeding the threshold, causing the second region to be included in a second frame at the resolution associated with the one or more second machine learning models.

5. The method of claim 1, further comprising causing an increase of the size associated with the region from a first resolution to a second resolution, the second resolution including less points or pixels than the resolution associated with the one or more second machine learning models, wherein the causing of the region to be included in the subset of the frame comprises causing the region to be included in the subset of the frame at the second resolution.

6. The method of claim 1, wherein the resolution associated with the one or more second machine learning models corresponds to one or more resolutions associated with one or more frames of image data used to train the one or more second machine learning models.

7. The method of claim 1, wherein the size associated with the region corresponds to a second resolution of the region, the second resolution including less points or pixels than the resolution associated with the one or more second machine learning models.

8. The method of claim 1, wherein the causing of the region to be included in the subset of the frame comprises causing one or more points of image data corresponding to the region to be mapped to one or more locations in the subset of the frame.

9. The method of claim 1, wherein the one or more regions within the one or more images correspond to one or more locations associated with one or more objects depicted in the one or more images.

10. A system comprising:
one or more processors to:
determine that a size associated with an object represented in image data is smaller than a threshold;
in response to the determination that the size is smaller than the threshold, cause at least a portion of the image data corresponding to the object to be incorporated into a frame at a first resolution that is less than a second resolution associated with one or more machine learning models; and
provide the frame to the one or more machine learning models, the one or more machine learning models to determine one or more predictions corresponding to the object.

11. The system of claim 10, the one or more processors further to determine that a difference between a first aspect ratio associated with the first resolution and a second aspect ratio associated with the second resolution is greater than a second threshold, wherein the causing of the portion of the image data to be incorporated into the frame at the first resolution is further based at least on the difference being greater than the second threshold.

12. The system of claim 10, the one or more processors further to:
determine that a second size associated with a second object depicted in the image meets or exceeds the threshold; and
in response to the determination that the second size meets or exceeds the threshold, cause at least a second portion of the image data corresponding to the second object to be incorporated into a second frame at the second resolution.

13. The system of claim 10, wherein a second size corresponding to the first resolution is larger than the size associated with the object.

14. The system of claim 10, wherein the second resolution associated with the one or more machine learning models corresponds to one or more resolutions associated with one or more images used to train or update the one or more machine learning models.

15. The system of claim 10, wherein a second size associated with at least one of the threshold or the frame corresponds to the second resolution associated with one or more machine learning models.

16. The system of claim 10, the one or more processors further to cause the one or more machine learning models to be updated using one or more frames corresponding to the second resolution, the one or more frames including one or more padded portions at least partially surrounding one or more images, the one or more images having one or more resolutions that are less than the second resolution.

17. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language model (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
one or more circuits to determine whether to adjust a size of an image identified using one or more first machine learning models based at least on evaluating the size of the image with respect to a threshold, the threshold related to an input resolution associated with one or more second machine learning models.

19. The one or more processors of claim 18, the one or more circuits further to determine, based at least on the evaluating, to incorporate the image into a frame at a second resolution that includes less points or pixels than the input resolution associated with the one or more second machine learning models.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
